(19) United States
(12) Patent Application Publication
(10) Pub. No.: US 2026/0029371 A1
(43) Pub. Date: Jan. 29, 2026

(54) USE AND METHOD FOR DETECTING THE STATE OF AN ELECTROCHEMICAL SENSOR, AND CORRESPONDING ELECTROCHEMICAL SENSOR

(71) Applicant: Testo SE & Co. KGaA, Titisee-Neustadt (DE)

(72) Inventors: Gregor STEINER, Titisee-Neustadt (DE); Janosch KNEER, Freiburg (DE); Peter LIEBETRAUT, Gundelfingen (DE)

(73) Assignee: Testo SE & Co. KGaA, Titisee-Neustadt (DE)

(21) Appl. No.: 19/282,106

(22) Filed: Jul. 28, 2025

(30) Foreign Application Priority Data
Jul. 29, 2024 (EP) 24191531.3

(51) Int. Cl. G01N 27/416; G01N 27/30

(52) U.S. Cl. CPC G01N 27/4163; G01N 27/301

(57) ABSTRACT

A variable of an electrochemical sensor (1), correlating with a voltage between two electrodes, for detecting the operating state of the sensor, and a method for detecting the operating state of an electrochemical sensor (1), in which a variable correlating with a voltage between the reference electrode (3) and the counter electrode (4) is recorded. An apparatus with an electrochemical sensor (1) for use according to the method is also provided.

### CROSS-REFERENCE TO RELATED APPLICATIONS

This application claims priority from European Patent Application No. 24191531.3, filed Jul. 29, 2025, which is incorporated herein by reference as if fully set forth.

### TECHNICAL FIELD

The invention relates to the use of a variable of an electrochemical sensor, correlating with a voltage between two electrodes, for detecting the operating state of the sensor.

Furthermore, the invention deals with a method for detecting an operating state of an electrochemical sensor, wherein the sensor comprises at least a sensing electrode, a counter electrode and a reference electrode.

The invention further relates to an apparatus for using a method described in accordance with the method claims.

### BACKGROUND

Such electrochemical sensors are known and are used, for example, to measure oxygen in the air or to monitor processes when measuring ammonia. In particular, electrochemical oxygen sensors are used, among other things, in the field of personal safety, in emission and exhaust gas measurement technology in portable and stationary devices.

It has been found that the performance of these sensors can drop due to use, on account of aging processes and/or as a result of improper handling.

### SUMMARY

The invention is based on the object of easily detecting the operating state of a sensor.

This object is achieved by the use of a variable of an electrochemical gas sensor, correlating with a voltage between two electrodes, for detecting the operating state of the sensor. Thus, the characteristic variable can be used to determine and assess the sensor state and to make statements about the state of the sensor. This allows easy assessment of the operating state of the electrochemical sensor when installed and/or without complex measurement setups or test series.

Alternatively or additionally, one or more of the features disclosed herein, directed to a method, are provided according to the invention in order to achieve the stated object. In order to achieve the stated object in methods of the type described at the outset, it is therefore provided according to the invention that at least one variable correlating with a voltage between the reference electrode and the counter electrode is recorded. Thus, a large number of analytical statements about the current and the previous state of the sensor can be obtained.

In particular, the potential difference between the counter electrode and the reference electrode (U_{CE-RE}) can be used as a characteristic signal variable which is influenced by environmental variables such as temperature or moisture content and specific disturbance variables such as solvent vapors. In this case, the signal variable is characteristic of each individual sensor and is recorded individually.

As a result, for example, states that induce changes in the sensor structure can be detected at an early stage, and service measures can be taken in accordance with this in order to thus increase device availability for the customer.

The early detection and determination of the sensor state makes it possible to output specific information when using the device, for example for operation and storage. The corresponding information on the state of the sensor makes it possible to assess measurement inaccuracies and/or the reduction of measurement accuracies.

Furthermore, it is also possible, for example, to identify storage that is not in line with the specifications or to identify a state trend outside the specification.

In one advantageous configuration, provision may be made for the at least one variable correlating with a voltage between the reference electrode and the counter electrode to be evaluated. Thus, various device states and influencing factors can be detected and evaluated. The state detection in the device allows, for example, the creation of defined user statistics for customer service. This makes it possible, for example, to derive region-specific load parameters or to identify recurring incorrect and/or impairing device storage and device care, for example when cleaning with disinfectants.

For example, the evaluation can be carried out by comparison with a reference value that is preferably stored.

In one advantageous configuration, provision may be made for the correlating variable to be recorded as a potential difference between the at least two electrodes, in particular to be determined as a potential difference between at least one first electrode and at least one second electrode and/or at least one third electrode of the sensor. It is therefore possible to use the potential difference as a characteristic signal variable without the need to interrupt measurement operation and thus regulate the sensor afterward.

It can be observed that the voltage difference between the reference electrode and the counter electrode increases after a current supply interruption or disconnection of a fault, in which case the current falls after a current supply interruption, while it initially falls when contamination occurs, and increases again after it has subsided.

In this case, it is possible to define different threshold values that reflect specific conditions of the sensor or the sensor state.

In the case of very high contamination of the sensor, for example with solvents, an extremely pronounced shift in the reference electrode potential and thus also in the potential difference between the counter electrode and the reference electrode can occur, and so the sensor changes into a faulty function in which the sensor electrolyzes its electrolyte fluid and irreversible damage to the sensor can subsequently occur. As a workaround, it is possible to define a threshold value at which a temporary safety shutdown of the sensor occurs in order to avoid the transition to this malfunction. This threshold value can be selected to be between values of 400 and 600 mV with respect to the reference value during the initial sensor calibration. One particularly advantageous configuration of such a threshold value is 450 mV above the reference value during the initial sensor calibration.

In one advantageous configuration, provision may be made for at least one first electrode to be in the form of a reference electrode and for at least one second electrode to be in the form of a counter electrode. Thus, the actual material and transport events of the sensor can be described and calculated according to Faraday laws, and characteristic variables of the specific sensor can be recorded.

Electrodes having an equilibrium potential that is both constant and rapidly and reproducibly adjusted are referred to as reference electrodes, for example. Such reference electrodes are used, for example, as a reference point for measuring preferably relative potentials of further electrodes.

In electrochemistry, an electrode that is used in an electrochemical cell having three electrodes for voltammetric analyses or other reactions in which an electrical current is intended to flow is referred to as a counter electrode, for example. The counter electrode often differs from the reference electrode, which defines the electrical potential against which other potentials can be measured, and/or from the sensing electrode, at which the cell reaction takes place.

In one embodiment of the invention, the voltage between the reference electrode and the counter electrode is measured directly, preferably without current, as the correlating variable.

In one advantageous configuration, provision may be made for the correlating variable to be recorded without current. Thus, the actual measurement between the sensing electrode and the reference electrode is not affected.

In one advantageous configuration, provision may be made for the correlating variable to be recorded on the basis of a temporal development. This makes it possible to detect not only the state of the sensor, but also the speed at which this sensor undergoes a state change. For example, the regeneration behavior of the sensor after contamination can be recorded and statements can be made as to when the sensor is fully operational again.

In one advantageous configuration, provision may be made for the correlating variable to be recorded in comparison with a reference value. It is therefore possible to define, based on the comparison of the correlating variable with the reference value, threshold values which indicate when specified sensor conditions are possibly exceeded. For example, these threshold values can be communicated to the user in a status display by means of a simple presentation, for example by means of a traffic light scheme or by a warning signal.

In one advantageous configuration, provision may be made for the at least one measured value to be compensated for. Thus, for example, the influence of temperature on the measurement effect can be canceled. It is also conceivable for the measurement results, which have been falsified due to external influences such as contamination, to be compensated for.

In one advantageous configuration, provision may be made for at least one state variable and/or state statement to be determined from the at least one correlating variable. The measurement therefore makes it possible to infer the sensor state, for example with regard to its moisture and/or electrolyte concentration.

In one advantageous configuration, provision may be made for at least one environmental condition and/or at least one operating condition to be determined from the at least one correlating variable. This allows conclusions to be drawn about storage, operation and acute and/or recent contamination by organic components of the sensor.

For example, it is possible to determine environmental variables such as temperature or moisture content of the air, as well as specific disturbance variables such as solvent vapors.

In one advantageous configuration, provision may be made for at least one correlating variable to be recorded and transmitted to at least one evaluation unit. This means that, when a critical threshold value is reached, warnings about a malfunction, an impending sensor defect or information on the correct use of the device and storage can be given.

It is particularly advantageous if the calculation and evaluation of the necessary sensor signals are recorded integrally in a causal sequence and the calculations are as simple as possible in order to be able to be integrated into the given microcontroller architecture.

This can therefore be effected for the user in various signaling formats, for example in the form of a traffic light scheme.

A status display when a threshold value is exceeded would be presented in the exemplary manner below:

Achieving an increase of, for example, 100 mV in comparison with production adjustment corresponds to leaving a range of climatically typical conditions of use and represents a useful first threshold value for signaling and operating instructions. An increase of, for example, 135 mV corresponds to an internal state in which optical changes in the material characteristics are observed and can therefore be defined as a second alarm threshold. An increase of, for example, 160 mV corresponds, for example, to the maximum specified operating parameter being exceeded and would therefore define the third alarm threshold for triggering warnings and warning signaling.

In one advantageous configuration, provision may be made, for at least one correlating variable, for a distinction to be made between at least one static and at least one dynamic state change. It is thus possible to use the determined values to present effects on the sensor signals during state monitoring and fault detection in a representable manner.

In one particularly exemplary embodiment, the knowledge of a state that is not in line with the specifications or the approximation to such a state allows timely service measures to be taken (e.g. replacement of the sensor) in order to guarantee the user improved availability or to prevent irreversible changes which are detrimental to the service life.

In one advantageous configuration, provision may be made for at least one correlating variable to be used to adjust the electrode. This makes it possible to make statements about the maximum fault tolerance of the sensor and to derive indications as to the time period in which the full functionality within the specification of the sensor is achieved again.

In one advantageous configuration, provision may be made for at least one state variable and/or state statement to indicate contamination of the sensor and/or an interruption of operation and/or current supply interruption. Thus, conclusions about the state of the sensor can be drawn quickly and operating instructions and/or recommendations for the user can be derived. It is particularly advantageous if operating instructions and recommendations such as “Measurement with a maximum fault tolerance of [ ]% of the measured value” or “Expected waiting time until the return to the fully specified functionality in [ ]h” can be derived and made available in this case.

In one advantageous configuration, provision may be made for at least one sensor to be a gas sensor or a fluid sensor. Thus, the state of the sensor can be determined in different areas of application with the aid of the method according to the invention and thereby a higher measurement accuracy can be achieved.

For example, the gas sensor maybe in the form of an O₂ pump sensor, a CO sensor, an H₂O sensor, an NO sensor, an NO₂ sensor, or an NH₃ sensor. In a further embodiment, the sensor may be a fluid sensor, for example for blood analysis.

Alternatively or additionally, the features of the coordinate claim, which is directed to an electrochemical sensor, are provided according to the invention in order to achieve the stated object. In particular, in order to achieve the stated object in an apparatus of the type described at the outset, it is therefore proposed according to the invention that, in an electrochemical sensor having at least a sensing electrode, a counter electrode and a reference electrode, a variable correlating with a voltage between the reference electrode and the counter electrode can be recorded. For this purpose, measurement means may be designed to record the variable, for example. Thus, with regard to the use of a measurement device with an electrochemical sensor, information about the state of the sensor can be detected and output, for example.

For example, means may be designed here to carry out a method according to the invention, in particular as described above and/or as claimed in one of the claims below.

For example, it is possible to identify storage that is not in line with the specifications and to take appropriate service measures such as replacing the gas sensor, in order to thus ensure improved availability of the measurement arrangement. It is also possible to prevent, for example, the state of the sensor from being changed irreversibly and therefore being harmful for the service life of the sensor.

### BRIEF DESCRIPTION OF THE DRAWINGS

The invention will now be described in more detail with reference to an exemplary embodiment, but is not restricted to the exemplary embodiment. Further exemplary embodiments emerge from combining the features of individual or multiple claims with one another and/or with individual or multiple features of the exemplary embodiment.

In the drawing:

FIG. 1 shows a three-dimensional overall view of an EC sensor,

FIG. 2 shows a schematic electrode arrangement,

FIG. 3 shows a schematic representation of the electrodes and their formed potentials, and

FIG. 4 shows a flowchart of the program sequence and for calculation.

### DETAILED DESCRIPTION

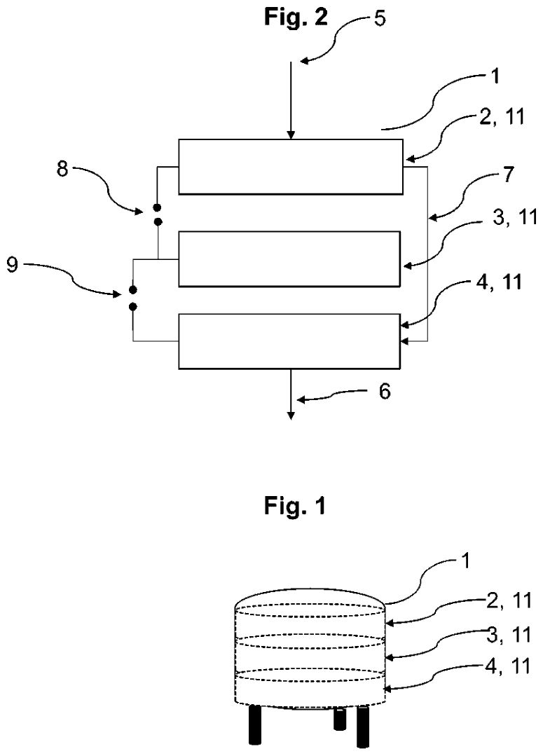

FIG. 1 shows an arrangement of an electrochemical sensor 1 according to the invention. The electrochemical sensor 1 comprises a sensing electrode 2, a reference electrode 3 and a counter electrode 4 as electrodes 11. Such electrochemical sensors 1 may be, for example, gas sensors or fluid sensors and are used, for example, to measure oxygen in the air or to measure ammonia during monitoring in processes.

In order to detect the operating state of the sensor 1, use is made of a variable which correlates with a voltage between two electrodes 11, in particular with a voltage between the reference electrode 3 and a counter electrode 4.

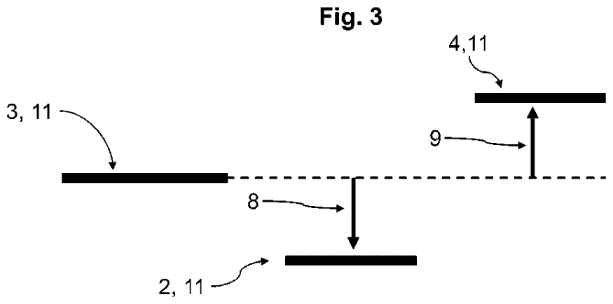

As shown in FIG. 3, for the operation of the sensor 1, the potential of the sensing electrode 2 is reduced by, for example, 600 mV with respect to the reference electrode 3.

After current has been supplied to the sensing electrode 2, the oxygen is reduced (O₂+4H⁺+4e→2H₂O). In order to establish a material and charge balance, a counter-reaction must take place here. This means that an opposite reaction takes place at the counter electrode 4 and water is electrolytically decomposed and oxygen (2H₂O→O₂+4H⁺4 e⁻) is released. As a result, the potential U_{CE-RE} 9 of the counter electrode 4 increases with respect to the reference electrode 3. After reaching a stable gradient of the oxygen concentration between the sensing electrode 2 and the counter electrode 4, an equilibrium position is present with a constant current supply.

The potential difference U_{SE-RE} 8 is predetermined exclusively by the control electronics, whereas the potential difference U_{CE-RE} 9 is the result of the actual material conversion and transport events, and is thus a correlating variable of the sensor 1.

With the aid of the measurement of the potential difference U_{CE-RE} 9 as a characteristic variable, it is therefore possible to determine the actual potential level of the reference electrode 3 and the counter electrode 4 as a correlating variable and to use it to determine and assess the operating state of the sensor 1. The potential difference U_{CE-RE} 9 is influenced by the environmental variable or operating conditions such as temperature or moisture content of the air, as well as by specific disturbance variables such as solvent vapors.

In order to avoid any impairment in the actual measurement between the sensing electrode 2 and the reference electrode 3, the measurement should ideally be performed as well as possible without current.

FIG. 3 shows a schematic representation of the electrodes 11 and their formed potentials 8, 9 in an exemplary manner for an O₂ sensor under stable standard conditions (25° C., 1 atm). Under standard conditions, the potential difference U_{CE-RE} 9 between the counter electrode 4,11 and the reference electrode 3,11 will result in a characteristic expected value of approx. 550 mV. This value is used as a reference value for further measurements. The potential level of the counter electrode 4, 11 is significantly dependent on the amount of O₂ present. If less O₂ is produced due to environmental conditions and/or operating conditions that existed or currently exist, for example, the potential level of the counter electrode 4 decreases and leads to a changed potential difference U_{CE-RE} 9.

This makes it possible to define, for example, various threshold values that reflect specific conditions and/or operating states of the sensor. For example, threshold values, which are determined on the basis of a temporal development, can give a statement about the state, for example with regard to the degree of dehydration of the sensor 1.

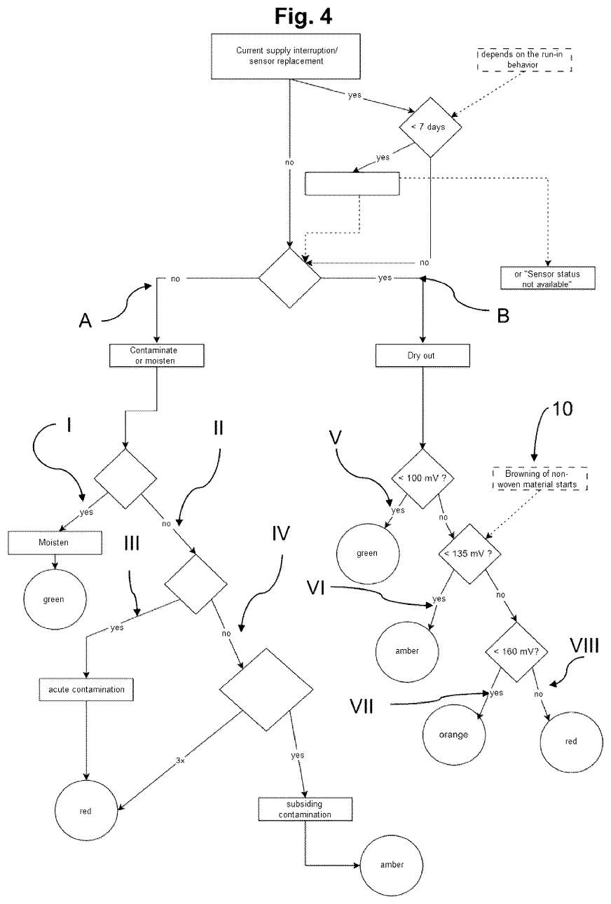

FIG. 4 shows in an exemplary manner a program sequence as a flowchart which takes into account the already previously mentioned fault effects and shows by way of example the concatenation and calculation of the necessary sensor signals in a causal sequence.

Ideally, the calculations are as simple as possible and can thus be embedded in the predefined microcontroller architecture. In this case, the flowchart takes into account the usual starting and boundary conditions when using the electrochemical sensor 1 in the measurement device.

The prerequisite for checking the operating state of the electrochemical sensor 1 is that it was supplied with current over a sufficiently long period, for example over 7 days, and thus equilibrium conditions existed. If this is the case, the currently determined potential difference 9 (U_{CE-RE}) between the reference electrode 3 and the counter electrode 4 is compared with the potential difference (U_{CE-RE, n-1}) recorded during the last use of the device as the reference value. If this is not available, the value can be compensated for by the determined potential difference during production adjustment (U_{CE-RE, SPC}). With the aid of the correlating variable, it is possible to determine a current state statement and/or a state variable of the sensor 1.

For example, a state variable and/or a state statement may indicate contamination of the sensor, an interruption of operation, or a current supply interruption.

In this case, as shown in FIG. 4, it is possible to distinguish whether there is a static or dynamic state change. Based on this information on the correlating variable, it is possible to readjust the electrodes 11, for example.

Various states of the electrochemical sensor are described below. For example, an environmental condition and/or an operating condition can be determined from the correlating variable and displayed. The correlating variable is recorded and transmitted to an evaluation unit.

For example, if the difference between the two values is greater than 0, case A, a check is carried out in order to determine whether the sensor is rewetted from the dry state or whether the sensor is contaminated.

If there is no current flow 7 (I_{sens,i}−I_{sens,n-1}=0+ε), branch I, the sensor is “rewetting” and therefore normally operational, and the signal is green.

If the value of the current flow 7 is not equal to 0 (I_{sens,i}−I_{sens,n-1}≠0), branch II, the following conditions are distinguished, for example:

If the current flow 7 is greater than 0 (I_{sens,i}−I_{sens,n-1}<0), branch III, this is potential contamination. For example, an alarm message indicating that measurement is not possible and a red signal may light up here.

If the current flow 7 is less than 0 (I_{sens,i}−I_{sens,n-1}>0), branch IV, the contamination of the sensor is subsiding. For example, the measurement device may provide measurement suggestions, such as “Measurement possible with an expected reduced accuracy of 3% of the measured value” or “Measurement outside the specifications”, and an amber signal message also appears.

If the potential difference 9 is greater than 0, case B, the sensor is drying out.

Here, for example, different conditions of the state of the electrochemical sensor 1 can be distinguished:

If the potential difference 9 is less than, for example, 100 mV, branch V, the sensor is in the state window for normal operation, and a green signal message appears.

If the potential difference 9 is above, for example, 100 mV, branch VI, the state of the sensor is outside the typical operating conditions, for example, and an indication or an amber signal message appears.

For a potential difference 9 of greater than, for example, 135 mV, branch VII, first optical changes may occur in the material structure of the electrochemical sensor 1. For example, browning of the non-woven material starts here. The changes in the material structure can lead to an impairment of the service life of the sensor and, in order to prevent this, a warning is sent in the form of an orange signal message.

If there is, for example, a potential difference 9 of greater than, for example, 160 mV, branch VIII, the sensor is used outside its specification. For example, the measurement device then sends a user notice that the sensor has been stored outside the specification, and a red warning signal appears.

The invention relates to the use of a variable of an electrochemical sensor 1, correlating with a voltage between two electrodes, for detecting the operating state of the sensor. The invention further relates to a method for detecting an operating state of an electrochemical sensor 1, wherein a variable correlating with a voltage between the reference electrode 3 and the counter electrode 4 is recorded. The invention further comprises an apparatus of an electrochemical sensor 1, having a sensing electrode 2, a reference electrode 3 and a counter electrode 4, wherein a variable correlating with the voltage between the reference electrode 3 and the counter electrode 4 is recorded.

List of Reference Signs

| | |
|---|---|
| 1 | Sensor |
| 2 | Sensing electrode (SE) |
| 3 | Reference electrode |
| 4 | Counter electrode (CE) |
| 5 | Inflow of the measurement fluid |
| 6 | Outflow |
| 7 | Current flow Iₛ |
| 8 | Potential difference U_{SE-RE} |
| 9 | Potential difference U_{CE-RE} |
| 10 | Sensor state change |
| 11 | Electrode |
| A | Case |
| B | Case |
| I | Condition |
| II | Condition |
| III | Condition |
| IV | Condition |
| V | Condition |
| VI | Condition |
| VII | Condition |
| VIII | Condition |

1. A method for detecting an operating state of an electrochemical sensor (1), the method comprising:
providing the sensor having a plurality of electrodes, including at least a sensing electrode (2), a counter electrode (4) and a reference electrode (3); and
recording at least one variable correlating with a voltage between at least two of the electrodes (11).

2. The method as claimed in claim 1, wherein the voltage is recorded between the reference electrode (3) and the counter electrode (4).

3. The method as claimed in claim 2, wherein the at least one variable correlating with the voltage between the reference electrode (3) and the counter electrode (4) is evaluated based on a reference value.

4. The method as claimed in claim 2, wherein, as the at least one variable, a potential difference between the at least two of the electrodes (11) is recorded.

5. The method as claimed in claim 4, wherein the potential difference between at least a first one of the electrodes and at least a second one of the electrodes (11) and/or at least a third one of the electrodes (11) of the sensor is determined.

6. The method as claimed in claim 5, wherein the at least one first electrode (11) comprises the reference electrode (3) and the at least one second electrode (11) comprises the counter electrode (4).

7. The method as claimed in claim 1, wherein the at least one variable correlating with the voltage is recorded without current.

8. The method as claimed in claim 7, further comprising measuring the voltage between the reference electrode (3) and the counter electrode (4) as the at least one variable correlating with the voltage.

9. The method as claimed in claim 8, wherein the at least one variable correlating with the voltage is recorded based on a temporal development and/or in comparison with a reference value.

10. The method as claimed in claim 8, wherein the at least one measured value is compensated for.

11. The method as claimed in claim 1, further comprising determining at least one state variable and/or state statement from the at least one variable correlating with the voltage.

12. The method as claimed in claim 1, further comprising determining at least one environmental condition and/or at least one operating condition from the at least one variable correlating with the voltage.

13. The method as claimed in claim 1, further comprising recording and transmitting the at least one variable correlating with the voltage to at least one evaluation unit.

14. The method as claimed in claim 1, further comprising, for the at least one variable correlating with the voltage, making a distinction between at least one static and at least one dynamic state change.

15. The method as claimed in claim 1, further comprising using the at least one variable correlating with the voltage to readjust the electrode.

16. The method as claimed in claim 1, wherein the at least one variable correlating with the voltage and/or a state statement indicates at least one of a contamination of the sensor (1), an interruption of operation, or a current supply interruption.

17. The method as claimed in claim 1, further comprising, when a defined threshold value is exceeded, carting out a safety shutdown of the sensor.

18. The method as claimed in claim 1, wherein the sensor (1) is a gas sensor or a fluid sensor.

19. An electrochemical sensor (1), comprising:
a sensing electrode (2);
a counter electrode (4); and
a reference electrode (3),
wherein a variable correlating with a voltage between the reference electrode (3) and the counter electrode (4) is adapted to be recorded for detecting an operating state of an electrochemical sensor (1).
